(19) United States
(12) Patent Application Publication
(10) Pub. No.: US 2026/0320209 A1
(43) Pub. Date: Oct. 15, 2026

(54) RECOGNITION OF EXTERNAL INTERVENTIONS IN A COMPUTER SYSTEM WITH ZONE SEPARATION FOR A DEVICE, IN PARTICULAR FOR A VEHICLE

(71) Applicant: Robert Bosch GmbH, Stuttgart (DE)

(72) Inventors: Manuel Jauss, Wissgoldingen (DE); Lara Hallaczek, Stuttgart (DE); Marcel Kneib, Ingelheim (DE)

(21) Appl. No.: 19/112,066

(22) PCT Filed: Sep. 6, 2023
(86) PCT No.: PCT/EP2023/074472

§ 371 Date: May 1, 2025

(30) Foreign Application Priority Data
Sep. 16, 2022 (DE) 10 2022 209 777.7

(51) Int. Cl. G06F 21/62; G06F 21/55

(52) U.S. Cl. CPC G06F 21/6218; G06F 21/554; G06F 2221/2141

(57) ABSTRACT

A computer system for providing a plurality of functions for a device, in particular for a vehicle. The computer system has system modules, system resources, and a security module. The system modules are configured to provide functions for the device. A first zone from a plurality of zones is assigned a first number of system modules and/or parts of system modules. A second zone is assigned a second number of system modules and/or parts of system modules. The first zone is assigned a first number of system resources. The second zone is assigned a second number of system resources. The security module recognizes violations of rules relating to the assignment of the first number of system resources for the first zone and violations of rules relating to the assignment of the second number of system resources for the second zone.

### FIELD

The present invention relates to techniques for providing a plurality of functions for a device, in particular for a vehicle. Related aspects relate to a computer-implemented process and a computer program.

### BACKGROUND INFORMATION

Recently, vehicles have been increasingly networked with one another and/or with a backend located in a cloud. More precisely, the vehicles comprise one or more interfaces via which data are received and/or sent during the operation of a vehicle, which in turn are used for the operation of the vehicle. In addition, the complexity of vehicle components and their software is constantly increasing, in particular in connection with autonomous or semi-autonomous vehicles and the demand for “smarter mobility”, which implies the integration of the vehicle into the digital world. Therefore, cyber security is playing an increasingly important role in the development of software and hardware for modern vehicles. In addition, problems with some methods in the related art in relation to cyber security arise from the variety of applications that are provided by different manufacturers and are executed on different systems in the vehicle.

In this connection, some methods in the related art are based on the concept of zone separation, i.e. the concept of separating trust zones within an electronic control unit (ECU), as a result of which more exposed components are isolated from less exposed components in order to reduce the attack surface.

However, some methods under the related art are not capable of recognizing intervention attempts in various zones on a timely basis and responding accordingly.

Therefore, there is a need to develop new efficient techniques that can solve some or all of the aforementioned problems.

### SUMMARY

A first general aspect of the present invention relates to a computer system for providing a plurality of functions for a device, in particular for a vehicle. According to an example embodiment of the present invention, the computer system of the first aspect has a plurality of system modules, a plurality of system resources and a security module, wherein the plurality of system modules are configured to provide functions for the device. In addition, a first zone from a plurality of zones is assigned a first number of system modules and/or parts of system modules of the plurality of system modules. In addition, a second zone from the plurality of zones is assigned a second number of system modules and/or parts of system modules of the plurality of system modules. A zone of the first aspect is a logically and/or physically delimitable unit in the computer system, wherein the first zone is assigned a first number of system resources from the plurality of system resources. In addition, the second zone is assigned a second number of system resources from the plurality of system resources. The security module of the first aspect is designed to recognize violations of rules relating to the assignment of the first number of System resources of the plurality of system resources for the first zone and violations of rules relating to the assignment of the second number of system resources of the plurality of system resources for the second zone.

A second general aspect of the present invention relates to a computer-implemented method for providing a plurality of functions for a device, in particular for a vehicle, by a computer system. According to an example embodiment of the present invention, the method of the second aspect comprises enforcing a zone separation in the computer system. Furthermore, the method comprises providing the plurality of functions for the device, in particular for the vehicle. Finally, the method comprises recognizing violations of rules relating to an assignment of system resources that are assigned to at least two zones from a plurality of zones.

A third general aspect of the present disclosure relates to a computer program containing instructions that, when executed by a computer system, cause the computer system to perform the computer-implemented method according to the second general aspect of the present invention.

The techniques of the first to third general aspects can have one or more of the following advantages.

First, the present techniques can realize a stronger differentiation of security requirements in a computer system (e.g., vehicle computer) than in some techniques under the related art by dividing the computer system into zones (for example, the zones can have different trustworthiness levels in relation to one another) and assigning system modules of the computer system to the corresponding zones (e.g., according to the degree of criticality of functions for a device that these system modules provide). As a result, zone separation in the computer system of the present techniques can reduce the probability that a successful manipulation in one zone will spread to other zones.

Second, the techniques of the present invention can recognize interventions in computer systems more efficiently than in some techniques under the related art. In particular, violations of rules relating to the assignments of system resources for different zones (e.g., unauthorized access of these zones to system resources) can indicate that an intervention has taken place, or even that the intervention has not taken place if the rules relating to the assignments of system resources for the zones have been complied with (e.g., these zones only access the authorized system resources).

Third, the present techniques offer the possibility of recognizing such violations of rules in a computer system of a device (for example, in a vehicle) in a centralized manner by a security module (and, for example, accumulating them and responding to them accordingly). Thus, the present techniques make possible a faster and clearer assessment than some techniques under the related art as to whether or not an intervention in the entire computer system has taken place.

Some terms are used in the present disclosure in the following way:

A “system module” can comprise a hardware and/or software unit that provides a plurality of functions for a device (for example, for a vehicle). A system module can comprise one or more processors, controllers, control units, (communication) interfaces, network components, software applications, software architectures, all other software and/or hardware components, parts of the aforementioned, or any combination thereof, or can be one or more of the aforementioned realizations of system modules. A system module or its part can be arranged in a zone or in a subzone.

A “zone” can be a logically (functionally) and/or physically (locally) delimitable unit in a system. In other words, two or more zones are logically delimited from one another if they are separated from one another on a software basis (for example, represent different logical models in a software), while two or more zones form physically distinct units if they are physically separated from one another (for example, are located in different computer units or parts thereof). A zone can comprise one or more system modules and/or a part and/or parts of one or more system modules. A zone can be defined, i.e. determined, by its components. All system modules or parts of system modules that are assigned to a zone can form the zone. A zone can comprise various computer units, computing cores, controllers, control units, memory units, peripherals, (communication) interfaces, network components, software applications, software architectures, bus systems (for example, CAN bus systems in vehicles), all other software and/or hardware components, parts of the above, or any combination thereof. A plurality of zones can form a complete system (for example, an entire computer system). In some examples, a “zone” can be divided into two or more “subzones”, which together can form this zone. A “subzone” can be a logically (functionally) and/or physically (locally) delimitable subunit of a zone. Similar to a zone, a subzone can comprise one or more system modules or parts thereof that are assigned to the corresponding zone.

The term “system resource” can refer to any resources that, in their entirety, ensure the (at least partial) executability of one or more functions of the computer system for a device (e.g., for a vehicle). A “system resource” can be a software and/or hardware component that provides services for system modules. For example, a system resource can comprise one or more memories, one or more peripherals (for example, peripherals internal to the vehicle and/or external to the vehicle), a system resource linked to the energy supply or any combination thereof. In principle, the term “software component” (or “software”) can be any part of a software of a component (e.g., a control device) of the present disclosure. In particular, a software component can be a firmware component of a component of the present disclosure. “Firmware” is software that is embedded in (electronic) components and performs basic functions there. Firmware is functionally fixed to the particular hardware of the component (so that one cannot be used without the other). It can be stored in a non-volatile memory, such as a flash memory or an EEPROM. A zone of the present disclosure can be allowed or denied access to a system resource. For example, a zone can be allowed access to a system resource by means of an access right (more on this below). A “system resource” can be assigned to a zone or subzone, or be independent of the zone separation in a computer system, i.e. not assigned to a zone or subzone.

The term “system resource” can also refer to a “communication resource” (e.g., a bus system, in particular a CAN bus system in a vehicle, or comprise parts thereof or be a bus system or parts thereof), which can, for example, comprise properties of a communication connection over a transmission path or a plurality of transmission paths in the computer system in the case of multipath communication (for example, using multipath TCP), which may be described as a set of transmission parameters (for example, by means of a data rate, transmission capacity, transmission latency, transmission bandwidth, transmission reliability or any combination thereof). The corresponding communication can be carried out, for example, between modules/components internal to the vehicle or external to the vehicle via one or more radio networks, for example 5G, LTE mobile radio networks or WLAN networks, or via near-field communication connections or Bluetooth. For example, communication resources can comprise communication interfaces (e.g., one or more of I2C, SPI, CAN, LIN, USB, PCIe, Bluetooth and Wi-Fi).

A “memory” can be a data memory or a data carrier on/in which data are stored (saved). A memory can be read out or written by a computer and/or any type of peripheral device. A memory can be a semiconductor memory and/or a magnetic memory or a memory based on a technology not mentioned here. A memory can be a volatile memory and/or a non-volatile memory. A memory can comprise one of DRAM, RAM, ROM, EPROM, HDD, SDD, etc. on/in which data are stored.

A “periphery” can be a component that can be connected to a (central) computer unit. Such a component may require control by the computer unit and, if necessary, initialization. A component can be a “vehicle component”. A periphery can comprise a part of a computer that offers functionalities that cannot be provided by a computing core itself, but by additional hardware. For example, a peripheral can comprise an analog-to-digital converter (ADC), a safety-related peripheral, a security-related peripheral (MPU, MMU or other), a timer or an interface, such as a serial peripheral interface (SPI) or another interface mentioned above.

The term “vehicle component” is understood to mean any internal component of a vehicle. A vehicle component can be an engine (e.g., an internal combustion engine, an electric motor, a hybrid engine or a fuel cell or parts of an engine, such as a turbocharger), a control device (e.g., an engine control unit), a battery or other energy-absorbing systems, components of a drive train (e.g., a transmission), assistance systems (e.g., brake assistants, lane departure warning systems, parking assistants), climate control systems, sensors or sensor systems (e.g., camera-based systems, LIDAR systems, RADAR systems, ultrasonic sensor systems) or electronic systems for controlling functions of the interior. A vehicle component can also be a part of the systems described above or a combination of a plurality of the systems described above (or parts thereof).

A “computer system” of the present disclosure can comprise a (for example, central) vehicle computer (e.g., a vehicle computer can form the computer system). The computer system can comprise systems within a vehicle (for example, system modules and/or vehicle components as defined above). In some cases, the computer system can also comprise systems outside the vehicle (for example, peripherals external to the vehicle, data cloud systems, other components, or any combination thereof). In this connection, a “vehicle computer” is a class of highly integrated electronic vehicle control units that are characterized by a much higher computing power compared to microcontroller-based ECUs. VCs are designed with at least one microprocessor and one communication interface. In addition, an in-vehicle computer can contain one or more physical or virtual switches, a system-on-a-chip (SoC) hardware with a plurality of CPU cores, co-processors along with powerful graphics cards, on which, for example by means of hypervisors, a plurality of virtual machines execute various operating systems connected via a virtual switch (e.g., implemented in the hypervisor). Alternatively or additionally, VCs can use container technologies based on the creation of a container to provide virtual resources. VCs generally execute complex software for a wide variety of tasks with a wide variety of requirements, in particular for time-critical and safety-critical functions. VCs communicate with other systems in the vehicle, in particular with vehicle components, user interfaces, and with other VCs or ECUs (any combination of these alternatives is also possible). VCs can also communicate with systems external to the vehicle, such as cloud systems, smartphones, charging infrastructure, traffic control technology or other vehicles. In addition, the computer system can contain a bus system with which a plurality of logical/physical communication connections can be realized between different components of the computer system (for example, by means of corresponding physical communication channels). One possible example of such a bus system in the vehicle sector is the controller area network bus system (CAN bus system).

In other cases, “a computer system” can comprise an embedded system (e.g., an embedded system can form the computer system). An embedded system is an electronic computer that is integrated into a technical context. An embedded system can perform regulation, control, monitoring functions or data processing tasks. In yet other examples (or in addition), “the computer system” can comprise one or more ECUs (e.g., one or more ECUS can form the computer system).

A “function” can be any task (or subtask) that is performed during the operation of a device. A function can relate to the control, regulation or monitoring of the device or a part of the device (e.g., a component of the device). Additionally or alternatively, a function can relate to data or signal processing in the device (e.g., a communication function). The term “function” in the automotive field comprises control-based functions of a vehicle, for example, functions of driving or parking assistance systems, functions for autonomous or semi-autonomous driving, functions of an entertainment system along with functions for receiving, transmitting and storing various data between different systems (for example, system modules and/or vehicle components) of the computer system (or any combination of the aforementioned functions). Within the scope of the present disclosure, functions in conjunction with air conditioning systems and/or electronic systems for controlling functions of the interior are also possible. A corresponding “system module” can be responsible for the executability of the function, which functional unit can communicate with corresponding other systems, e.g. components (for example, vehicle components), other system modules within the vehicle or functional units external to the vehicle (as mentioned above) or a combination of these.

A “software architecture” can be a structured and/or hierarchical arrangement of the system components along with a description of their relationships in a software system, wherein system components can be software parts whose relationships to one another and whose properties can be described by the software architecture. For example, the software architecture of “AUTOSAR” (Automotive Open System Architecture) is an open and standardized software architecture for electronic control units (ECUs) in the automotive sector. For example, the “AUTOSAR Classic Platform” and the “AUTOSAR Adaptive Platform” are two different software architectures.

A “security module” (for example, a central “security module”) can be a component for recognizing violations of rules relating to the assignment (or in other words “relating to the allocation”) of (allocated) system resources for the respective zones (including, e.g., system modules). Furthermore, the security module of the present disclosure may serve the purpose of centralized collection and processing of detected violations (more on this below). The security module can be a hardware unit that can have its own memory, a preconfigured hardware logic, one or more registers and an internal data connection. (A register can, for example, contain or describe memory areas). In addition, a security module can comprise respective logical and/or physical connections to the zones (including, e. g., system modules). In this connection, a security module can comprise one or more interfaces to the outside, e.g., to the zones, to a computing core, to one or more communication connections or any combination thereof. A security module can be part of a central processing unit (CPU). In some cases, the security module can be integrated into a vehicle computer or designed as a stand-alone component (for example, components internal to the vehicle or external to the vehicle component) that communicates with, for example, the vehicle computer (in the latter case, the computer system of the present disclosure can comprise the vehicle computer and the security module). The security module can communicate externally via appropriate communication protocols (e.g., with system modules, components, other parts of a computer system or any combination thereof).

A “domain controller” can comprise peripherals implemented in hardware and manage access rights, for example for memory and/or external peripherals. A domain controller can segregate different peripherals and/or protect the memory of a system, wherein a domain of a domain controller can be a contiguous area that has the same access rights to peripherals and/or memory. A domain controller can, for example, be an extended resource domain controller (XRDC), which is a periphery of the S32G274A processor implemented in hardware. The latter is a high-performance vehicle network processor from the S32G2 family of the semiconductor manufacturer NXP and is a system-on-chip (SoC) comprising a microcontroller (μC) and microprocessor components (μP components).

A “computing core” refers to the central part of a microprocessor, wherein a plurality of computing cores can also be present in a microprocessor. A calculation core can carry out arithmetic and/or logical operations on input data and/or information.

A “vehicle” can be any device that transports passengers and/or freight. A vehicle can be a motor vehicle (for example, a passenger car or a truck) but also a rail vehicle. A vehicle can also be a motorized, non-motorized and/or a muscle-powered two-or three-wheeler. However, floating and flying devices can also be vehicles. Vehicles can operate autonomously or at least semi-autonomously or be assisted. For example, the vehicle in the present disclosure can comprise a partially or fully autonomous robot (for example, an industrial robot).

### BRIEF DESCRIPTION OF THE DRAWINGS

FIG. 1 shows schematically an exemplary embodiment of a computer system 100 according to the first aspect for providing a plurality of functions for a device by means of separating a plurality of zones. The computer system of FIG. 1 comprises four zones 20-23 (dashed boxes), six system modules 30-35 and a security module 10. This figure also shows two computer units 40, 41 and five interfaces 50-54.

FIG. 2 illustrates an exemplary embodiment of the computer system (for the sake of simplicity, without the third zone 22), which in addition to the exemplary embodiment of FIG. 1 has peripherals 60, 61, two memories 62, 63 and a domain controller 70.

FIG. 3A shows a flow chart showing an exemplary embodiment of a computer-implemented method provided by a computer system according to the first aspect (for example, using a computer system shown in FIG. 1 or FIG. 2).

FIG. 3B shows a flow chart showing further possible method steps according to the second aspect.

### DETAILED DESCRIPTION OF EXAMPLE EMBODIMENTS

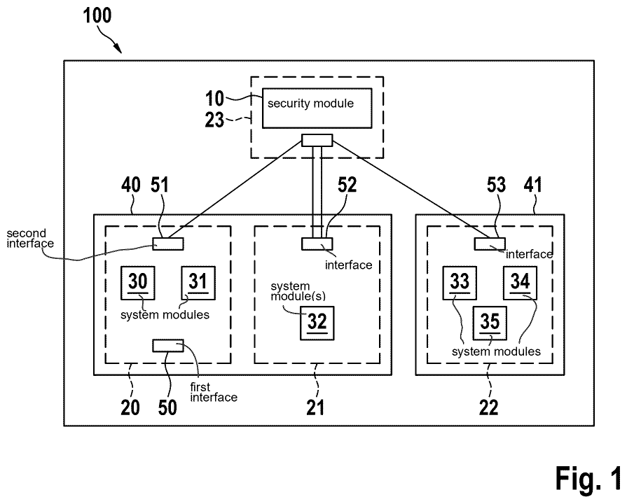

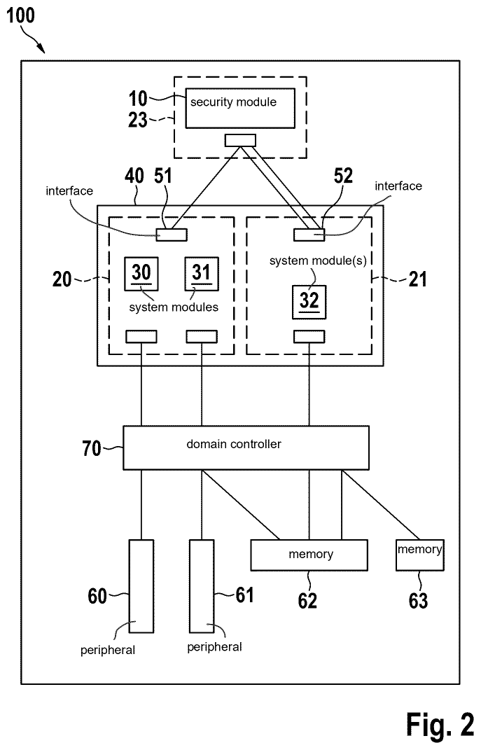

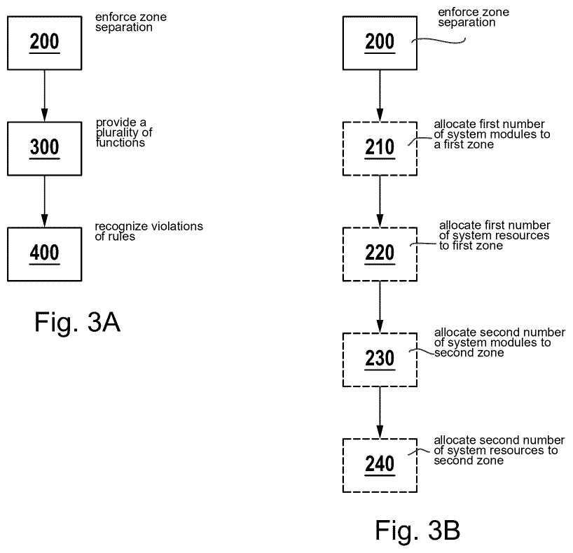

First, FIGS. 1 and 2 are used to describe techniques for providing a plurality of functions for a device (in particular for a vehicle) and exemplary structures of a computer system. Then, FIGS. 3A and 3B illustrate further aspects in relation to the method of the present disclosure.

A first general aspect relates to a computer system 100 (for example, a vehicle computer) for providing a plurality of functions for a device, in particular for a vehicle (for example, an autonomously or semi-autonomously operating vehicle), wherein the computer system comprises a plurality of system modules 30-35 (for example, hardware and/or software units, as mentioned above), a plurality of system resources 60-63 (for example, memory, peripherals internal to the vehicle or external to the vehicle, communication resources, such as for example a whole or part of a bus system, see discussions above) and a security module 10 (possible exemplary designs of such a computer system 100 are shown in FIGS. 1 and 2). The plurality of system modules of the first general aspect are configured to provide functions for the device (for example, functions for controlling, regulating or monitoring the device, as discussed above).

In the present techniques, a first number of system modules 30, 31 and/or parts of system modules are assigned to the plurality of system modules of a first zone 20 from a plurality of zones 20-23. In addition, a second number of system modules 32 and/or parts of system modules of the plurality of system modules are assigned to a second zone 21 from the plurality of zones. A zone is a logically and/or physically delimitable unit in the computer system (as defined above). For example, one or more, two or more, three or more, four or more, five or more, six or more, ten or more, twenty or more, fifty or more, one hundred or more zones can be separated in the computer system 100. In a non-limiting example of FIG. 1, four zones 20, 21, 22 and 23 along with six system modules 30 to 35 are shown. The two system modules 30, 31 (the first number of system modules in this example) are assigned to the first zone 20, while the one system module 32 (the second number of system modules in this example) is assigned to the second zone 21 (this arrangement is also shown in the exemplary embodiment of FIG. 2). In the same way as for the two zones 20 and 21, one or more other system modules or parts thereof that are not assigned to either of the two zones can be assigned to corresponding other zones that differ from the first and second zones. In the example of FIG. 1, three system modules 33, 34 and 35 are assigned to the third zone 22.

In some cases, one or more, two or more, three or more, four or more, five or more, six or more, ten or more, twenty or more, fifty or more, one hundred or more system modules (e.g., processors or other realizations of system modules as defined above) or parts thereof (e.g., computational cores) can be arranged in a zone. For example, the first zone 20 can comprise a part (e.g., two computational cores) of the plurality of computational cores of a processor (e.g., four computational cores) and the second zone 21 can comprise another part (e.g., two remaining computational cores) of the plurality of computational cores of the processor (not shown in the figures). For example, a first software application can be executed on a computing core of the processor that is assigned to the first zone 20 and a second software application can be executed on at least one computing core that is assigned to the second zone 21. In some examples, a zone can comprise interfaces, bus systems or parts thereof. In FIG. 1, the first zone 20, which comprises a first interface 50 and a second interface 51, a second zone 21, which comprises an interface 52, and the third zone 22, which comprises an interface 53, are shown by way of example. For example, an interface can comprise a CAN bus interface, a CAN FD bus interface and/or a GMAC port.

In the techniques of the present disclosure, a first number of system resources 60-62 (for example, software and/or hardware component) from the plurality of system resources 60-63 is assigned to the first zone 20. In addition, a second number of System resources 62, 63 from the plurality of system resources is assigned to the second zone 21 from the plurality of zones. In some cases, the second number of system resources 62 can differ from the first number of the plurality of system resources. As discussed above, “system resources” can provide corresponding services for system modules and are required, for example, for the executability of one or more functions of the computer system. The second number of system resources 62, 63 may be more limited than the first number of system resources 60-62. For example, the second number of system resources can comprise fewer system resources than the first number of system resources. Alternatively or additionally, the second zone 21 can have fewer access rights to the same or other system resources, as will be explained in more detail below. In a non-limiting example of FIG. 2, two peripherals 60, 61 and a memory 62 (the first number of system resources in this example) are assigned to the first zone 20 (for example, by means of a domain controller 70, more on this below), while two memories 62, 63 (the second number of system resources in this example) are assigned to the second zone 21. In the example of FIG. 2, the same system resource, namely the memory 62, is assigned to the two zones 20, 21 and the other system resources 60, 61 and 63 are in each case assigned to the first 20 and the second zone 21. In some cases, the same system resource can be assigned to two or more zones. In other cases, a system resource can only be assigned to one corresponding zone and no other zone.

The security module 10 of the present disclosure is designed to recognize violations of rules relating to the assignment of the first number of system resources 60-62 of the plurality of system resources for the first zone 20 and rules relating to the assignment of the second number of system resources 62, 63 of the plurality of system resources for the second zone 21. As explained below, for example, the first and/or second zones (for example, system modules assigned to these zones) can access an unauthorized system resource due to an external intervention (for example, the first zone 20 can have write access to the memory 62, although this zone may only have read access to the memory, more on this below). Furthermore, the security module 10 can be designed to recognize violations of rules relating to the assignment of system resources for the other zones (for example, for all remaining zones, such as for the third and fourth zones 22, 23 of FIG. 1). The security module 10 of the first aspect can comprise one or more logical and/or physical connections to a zone of the plurality of zones (for example, one or respective logical and/or physical connections to the first and second zones of the plurality of zones). In the examples of FIGS. 1 and 2, such connections are shown by solid lines from the security module 10 to the respective zones 20, 21, 22.

In the computer system 100 of the first aspect, the first zone 20 may be more trustworthy than the second 21, less trustworthy zone, wherein the risk of a manipulation of a more trustworthy zone is lower than that of a less trustworthy zone. Manipulating can comprise an external intervention (or in other words: an external intervention, for example a cyber attack) that reduces the operational reliability of the device. Further, in some cases, a third zone 22 of the plurality of zones may be more trustworthy than or equally as trustworthy as the first zone 20. In other cases, the third zone 22 may be more trustworthy than or equally as trustworthy as the second zone 21 and less trustworthy than the first zone. In still other cases, the third zone 22 may be less trustworthy than the second zone 21 and the first zone 20. In this way, other zones (for example, all zones) of the plurality of zones can also be classified in terms of how trustworthy they are in relation to one another.

The extent to which a zone of the plurality of zones is more trustworthy or less trustworthy, i.e. the degree of trustworthiness, can be based on a classification of zones 20-23 using a security level. The computer system of the present disclosure can have at least two levels of security, but can also have more than two levels of security (e.g., more than five). The degree of trustworthiness or the security level can be determined by the configuration of the corresponding zone (for example, the system modules contained therein). For example, the degree of protection, or the extent of security measures, with which the system modules of a zone 20-23 are protected, for example against manipulation, for example within the framework of an external intervention, can determine whether a zone 20-23 is more trustworthy or less trustworthy or what security level it has (e. g., the presence of certain hardware and/or software-based security measures in the system modules of the zone). Furthermore, for example, the extent of communication between the system modules arranged in the corresponding zone and external systems, such as a backend, can determine the degree of trustworthiness of a zone or the security level it has. For example, a zone that communicates predominantly or exclusively within the computer system may be more trustworthy than a zone that communicates at least partially with external systems (e.g., a backend, other devices, such as vehicles or infrastructure components).

In some examples, the zones can be divided, with respect to their trustworthiness, into untrustworthy zones and trustworthy zones. Two zones 20, 21 as described herein may, for example, be trustworthy and a less trustworthy third zone 22 may, for example, be untrustworthy (see FIGS. 1 and 2). The computer system 100, for example, a computer system of a vehicle, can be the target of a cyber attack, for example, as a result of which safety-critical functions, for example, a braking function in a vehicle, can be disabled or manipulated in such a way that a hazardous situation can arise. A more trustworthy zone 20, 21 is a zone that is less likely to be manipulated than a less trustworthy zone 22. For example, a zone 22 that comprises multimedia functions and comprises many interfaces for communicating with a backend may be a less trustworthy zone 22, since the likelihood of external intervention with a communication channel to the backend is higher than for a zone 20, which predominantly comprises functions that only require information from within the vehicle and/or only perform processes within the vehicle. In addition, the security module 10 responsible for violations of rules relating to the assignment of system resources for different zones can be assigned to the first zone 20 of the plurality of zones, or to another zone 23 of the plurality of zones that is more trustworthy than the first zone. In some cases, the security module 10 can be assigned to the most trustworthy zone 23 of the plurality of zones (e.g., the security module 10 can be assigned to the fourth most trustworthy zone 23, as illustrated by FIGS. 1 and 2).

In the present techniques, the functions provided by the system modules are of varying criticality for the operational reliability of the device. A first more critical function of the plurality of functions can be provided by a system module 30, 31 of the first zone 20 and a second less critical function of the plurality of functions can be provided by a system module 32 of the second zone 21. In some cases, two or more system modules (for example, all system modules) of the second zone can provide corresponding functions that are less critical than any functions provided by the system modules of the first zone. In addition to the classification of zones 20-23 according to a degree of trustworthiness, i.e. a security level, the zones are also classified with respect to their relevance for operational reliability (e.g., by means of a security level), i.e. the criticality of the function of the zone for the operational reliability of the device. A zone 20 whose manipulation can lead to a severe hazardous situation is more critical than a zone 21 whose manipulation cannot lead to a severe hazardous situation or can lead to a less severe hazardous situation. For example, a zone 21 that comprises multimedia functions may be less critical than a zone 20 that comprises, for example, a braking function. In the above example, the probability that the failure of the music in the interior of a vehicle will create a hazardous situation is less than the probability that the malfunctioning of a vehicle's brakes can cause a hazardous situation. In addition, a zone 23 to which the security module 10 is allocated may be more critical than one or more (for example, all) other zones of the plurality of zones. Returning to the example of FIG. 1: the fourth zone 23 is more critical than the other three zones 20, 21 and 22. A classification of the zones can be carried out in any suitable way using a security level or safety level or the relevance for the operational reliability of the device. In some examples, classification can be carried out by Automotive Safety Integrity Level (ASIL) classification, wherein the classification can comprise five levels (QM (least critical), ASIL-A, ASIL-B, ASIL-C and ASIL-D (most critical)). For example, the relevance, i.e. the criticality, of a zone for operational reliability can be derived from the severity, frequency, controllability of a safety hazard or any combination thereof in the particular zone.

In the present disclosure, one or more more trustworthy zones 20, 21 can be formed on a first computer unit 40 of the computer system and one or more less trustworthy zones 22 can be formed on a second computer unit 41 of the computer system. FIG. 1 shows an example of such a computer system 100 (for example, the computer system 100 can comprise a vehicle computer, a single-chip system or an embedded system, see also definitions above), which comprises a first computer unit 40 and a second computer unit 41. For example, a first trustworthy zone 20 and a second trustworthy zone 21 can be formed on the same computer unit 40 and a third non-trustworthy zone 22 can be formed on the second computer unit 41. For example, zones 20 and 21 can be logically separated from one another on a software basis. In some examples, the third zone 22 can be physically, i.e. locally, separated from the first zone 20 and/or the second zone 21 by forming it on a second computer unit 22.

In the present techniques, the zones from the plurality of zones can be allocated corresponding access rights to system resources. In other words, a zone can be denied access to a system resource or allowed access by means of an access right. The access rights can comprise authorized read, write, execute access or any combination thereof of a zone to a corresponding system resource. In some cases, one or more access rights allocated to a zone can remain unchanged over time (e.g., the access right can be predefined before the computer system is operated or during its operation). In other cases, one or more access rights allocated to a zone can change over time (e.g., a zone is allowed read access to a system resource when the computer system is started, while this zone is allowed read and write access to the same system resource at another point in time). In one example, access for a zone to a system resource can be classified as authorized if a predetermined criterion is met. In addition, access for the same zone to the system resource can be classified as unauthorized if the predetermined criterion is not met. The predetermined criterion can be a criterion relating to contextual information of the device and/or a plurality of devices, e.g. contextual information of a vehicle (or its vehicle components) and/or a fleet of vehicles. For example, the contextual information of the vehicle (or its vehicle components) can comprise information about an operational state of the vehicle (or its vehicle components) and/or about predetermined rules for operating the vehicle (or its vehicle components). (This definition can be similarly extended to the entire vehicle fleet). In another example, the predetermined criterion may require that an expected number of messages sent from a zone in a predetermined time period (for example, via a CAN bus system) must be less than or equal to a predetermined value (or greater than or equal to a predetermined value). In further examples, the specified criterion can comprise a specified sequence in which the data are sent from the zone and/or a specified range contained in the sent data of a particular type (for example, a value is between a predetermined value and another predetermined value and/or a predetermined pattern is contained therein). In still other examples, the predetermined criterion can comprise one or more of the aforementioned criteria.

In some cases, the second zone can be allocated fewer access rights to the second number of system resources than the first zone to the first number of system resources. Returning to the example of FIG. 2: the first zone 20 of the plurality of zones, which may be more trustworthy than the second, less trustworthy zone 21, may be granted an access right to use the memory 62 for reading and writing or for reading, writing and executing a software application. On the other hand, the second, less trustworthy zone 21 may be granted an access right to use the memory 62 for reading, while access for writing and/or executing a software application is denied.

In some examples, as shown in FIG. 2, the computer system can contain a domain controller 70 that contains a plurality of domains (the latter are not shown in this figure). A domain controller 70 can contain one or more, two or more, three or more, four or more, five or more, six or more, seven or more, eight or more domains. In the first aspect of the present techniques, a first domain of the plurality of domains can be allocated at least the first zone 20, and the first domain can have equal access rights of the first zone to system resources. In addition, a second domain of the plurality of domains can be allocated at least the second zone, and the second domain can have equal access rights of the second zone to system resources, wherein the second domain is allocated fewer access rights to system resources than the first domain (as described above in connection with the first and second zones). In other words, in some examples, a domain can be allocated system modules and/or parts of system modules with the same access rights, or a domain can be allocated the system modules and/or parts of system modules that require the same access rights to system resources in order to provide the corresponding functions. In some examples, the domain controller can be configured to allow or prohibit access by system modules 70 to system resources. In some examples, the access rights to system resources (for example, by means of the domain controller 70) can be allocated on the basis of the principle of least privilege (PoLP). This means that the zones in each case only have access rights to the system resources they need to perform their tasks. In other words, the system modules assigned to the zones in each case only have access rights to the system resources they need to provide the respective functions. In some examples, a domain can be allocated a trustworthiness (“security level”) . For example, a first domain (e.g., domain 0) of the plurality of domains (e.g., five domains) can be allocated a lower trustworthiness than a fifth domain (e.g., domain 5).

By means of the domain controller 70, in some examples zones 20, 21 can be allocated access rights to peripherals 60, 61 and/or memories 62, 63. For example, a domain can comprise a logical/physical region comprising equal access rights to memory 63 and/or peripherals 61, 62. In addition, in one zone of the plurality of zones (for example, in the first 20 or in another zone), a system module and/or a part of a system module can comprise a first software architecture, and in another zone of the plurality of zones (for example, in the second 21 or in another zone), another system module and/or a part of a system module can comprise a second software architecture. For example, in the first zone 20, a system module 30, 31 and/or a part of a system module can comprise an AUTOSAR Classic software architecture, and in the other zone 21, a system module 32 and/or a part of a system module can comprise an AUTOSAR Adaptive software architecture. For example, a system module 30, 31 and/or a part of a system module can be configured in the first zone 20 in order to execute a first operating system (e.g., Windows) and a system module 32 and/or a part of a system module can be configured in the second zone 21 in order to execute a second operating system (e.g., Linux).

In the present techniques, a violation of rules relating to an assigned system resource for a zone can correspond to unauthorized access by such zone to a system resource for which no access right is assigned to the corresponding zone. For example, the violations of the rules relating to the assignment of the first number of system resources of the plurality of system resources for the first zone can correspond to one or more unauthorized accesses by the first zone to one or more system resources for which no access rights are allocated to the first zone. Alternatively or additionally, the violations of the rules relating to the assignment of the second number of system resources of the plurality of system resources for the second zone can correspond to one or more unauthorized accesses by the second zone to one or more system resources for which no access rights are allocated to the second zone. For example, a violation of rules relating to the system resources assigned to the first zone (or another zone) can occur if the first zone (for example, a system module allocated to this zone) attempts to access a system resource (e.g., a memory) in write mode, although it is only authorized to access the system resource in read mode. In another example, a violation of rules relating to the system resources assigned to the first zone (or another zone) can occur if the first zone (for example, a system module allocated to this zone) attempts to execute a system resource (e.g., a software application), although it does not have access rights for executing this system resource.

In the present techniques, the security module 10 can be further configured to communicate with one or more zones 20, 21, 22 (for example, all zones) (for example, as described above, using corresponding logical and/or physical connections). As a result, the security module can be configured to collect information about access to system resources from one or more zones (e.g., each zone) of the plurality of zones. This information (for example, in the form of digital or analog signals, messages or the like) can be provided to the security module by the respective zones, for example. In some cases, the security module can be configured to send a request to obtain information about a zone's access to system resources at the zone, and the zone can transmit this information to the security module. Such a request can, for example, be carried out regularly once per a predetermined time interval and/or irregularly if the respective consecutive time intervals are different. For example, this information can be stored in a register of the zone, e. g., in a system module (for example, a memory unit) assigned to this zone, so that the security module can read this information. Alternatively or additionally, the zone itself can send this information to the security module (for example, regularly once per a predetermined time interval and/or irregularly if the respective consecutive time intervals are different), without the security module making this request. Furthermore, the security module can compare the information about accesses of one or more zones to system resources with information in relation to rules relating to the assignment of system resources for these zones. For example, the information about the assignment rules can be stored in the security module or in another system module with which the security module can communicate. On the basis of the result of the comparison, the security module of the present techniques can in some cases recognize whether violations of rules relating to the assignment of system resources for one or more zones have taken place. If, for example, the information about the zone's access to system resources does not match the information in relation to the rules relating to the assignment of system resources for this zone (e.g., because at least one unauthorized access of this zone to a system resource has been detected), the security module can classify this comparison result as a violation of rules. As discussed above, violations of rules relating to the assignment of system resources for the particular zone can occur due to an external intervention in the computer system (for example, in this zone or in one or more system modules of this zone).

In addition, the security module 10 of the first aspect, or another module with which the security module is in communication (e.g., in order to inform such module of corresponding violations of assignment rules, for example using a corresponding signal), can be configured to trigger a response in a manipulated zone in order to mitigate effects of manipulation by an external intervention on the computer system. The manipulated zone can correspond to a zone for which violations of rules relating to the assignment of system resources assigned to this zone have been recognized. The response can comprise initiating a countermeasure against the recognized violations within the manipulated zone. In some cases, such a countermeasure can comprise changing access rights to system resources assigned to the manipulated zone. For example, if a zone has two or more different access rights for using a system resource (for example, the zone 20 in the example of FIG. 2 is authorized to use memory 62 for reading, writing and executing), a number of access rights for using this system resource can be reduced as a countermeasure (for example, the zone 20 is authorized to use memory 62 only for reading as a countermeasure).

In other cases, the countermeasure can comprise blocking access to system resources assigned to the manipulated zone (for example, zone 20 is denied access to memory 62 as a countermeasure). In still other cases, the countermeasure in the manipulated zone can comprise shutting down the manipulated zone. In addition, the countermeasure can comprise sending information (for example, in the form of digital or analog signals, messages or the like) about the recognized violations of rules in the manipulated zone and/or other relevant information (for example, in the form of digital or analog signals, messages or the like) from the security module 10 to system modules 30, 31 belonging to the manipulated zone 20. The other relevant information can include, for example, the context information of the device and/or a plurality of devices described above, e.g., the context information of a vehicle (or its vehicle components) and/or a vehicle fleet. Alternatively or additionally, the countermeasure can comprise sending information about the recognized violations of rules in the manipulated zone and/or other relevant information from the security module 10 to system modules 32-35 belonging to the other non-manipulated zones. Alternatively or in addition to the above two alternatives, the countermeasure can comprise sending information about the recognized violations of rules in the manipulated zone and/or other relevant information from the security module to an external system (e.g., a backend, other devices, such as vehicles or infrastructure components). In some cases, the security module 10 (or the other module mentioned above) can be further configured to execute a routine (for example, a software program or code, such as a compiled code) as the response within the manipulated zone. For example, one or more of the countermeasures described above can be implemented in the computer system 100 using this routine.

Alternatively or in addition to the (possible) triggered response in the manipulated zone, the security module 10 or the other module with which the security module is in communication can be configured in the present techniques to trigger a response in a non-manipulated zone to mitigate effects of manipulation by the external intervention on the computer system. The response can comprise initiating a countermeasure in the non-manipulated zone as a result of recognized violations in the manipulated zone. In some cases, such a countermeasure can comprise changing access rights to system resources assigned to the non-manipulated zone. For example, if a first zone 20 of FIG. 2 is the manipulated zone, and the second (non-manipulated) zone 21 has two or more different access rights for using a system resource (for example, zone 21 can use memory 63 for reading, writing and executing), a number of access rights for using this system resource can be reduced by the second non-manipulated zone 21 as a countermeasure (for example, zone 21 is authorized to use memory 63 for reading only as a countermeasure). In other cases, the countermeasure can comprise blocking access to system resources assigned to the non-manipulated zone (for example, zone 21 is denied access to memory 63 as a countermeasure). In still other cases, the countermeasure in the non-manipulated zone can comprise shutting down the non-manipulated zone. In some cases, the security module 10 (or the other module mentioned above) can be further configured to execute a routine (for example, the routine mentioned above) as the response within the non-manipulated zone. For example, one or more of the countermeasures described above can be implemented in the computer system 100 using this routine.

As described in detail above, the security module 10 can send the information about the recognized violations of rules in the manipulated zone and/or the other relevant information to the system modules 30-35 belonging to the manipulated zone 20 and/or to the other non-manipulated zones 21, 22. (As discussed above, any information can, for example, be in the form of digital or analog signals, messages or the like). Alternatively or additionally, one or more system modules (for example, all system modules) of the plurality of system modules can be configured to query the security module 10 for information about the recognized violations in one or more manipulated zones or for other relevant information (so-called “polling”—a term well understood by a person skilled in the art). Such a query can, for example, be carried out regularly once per a predetermined time interval and/or irregularly if the respective successive intervals are different. Furthermore, the security module 10 can be configured to provide this information to the one or more system modules (for example, to send and/or allow this information to be read by the system modules). In addition, each of the one or more system modules of the plurality of system modules can be configured to identify, from information about the recognized violations, whether violations of rules relating to the assignment of system resources have occurred for one or more zones of the plurality of zones. In addition, each of the one or more system modules of the plurality of system modules can be configured to trigger a response in a corresponding zone to which that system module is assigned (for example, in a non-manipulated or manipulated zone, depending on to which zone the corresponding system module is assigned) if violations of rules relating to the assignment of system resources have been identified for at least one zone of the plurality of zones. The response can comprise initiating a countermeasure within the zone to which this system module is assigned. The countermeasure can, for example, contain one or more countermeasures that have been described above in connection with the security module. In some cases, the countermeasure can comprise, namely, changing access rights or blocking access to system resources assigned to the zone to which this system module is assigned. In other cases, the countermeasure can comprise shutting down the zone to which this system module is assigned.

A second general aspect of the present disclosure relates to a computer-implemented method for providing a plurality of functions for a device, in particular for a vehicle, by a computer system 100. In some cases, the method of the second aspect can be provided by a computer system 100 according to the first general aspect (for example, by the computer system shown in FIG. 1 or 2, or by another computer system). The method is shown by way of example in FIGS. 3A and 3B. The method steps are shown in the boxes drawn by solid lines in FIGS. 3A and 3B, while some optional steps are shown in the boxes represented by dashed lines. The method of the second aspect comprises enforcing 200 a zone separation in the computer system. The method further comprises providing 300 the plurality of functions for the device, in particular for the vehicle. Finally, the method comprises recognizing 400 violations of rules relating to an assignment of system resources assigned to at least two zones from a plurality of zones 20-23.

Further, the step of “enforcing 200” the second general aspect can comprise allocating 210 a first number of system modules 30, 31 and/or parts of system modules of a plurality of system modules to a first zone 20 of the at least two zones 20-23. In addition, the step of “enforcing 200” can comprise allocating 220 a first number of system resources 60-62 from a plurality of system resources 60-63 to the first zone. In addition, the step of “enforcing 200” can comprise allocating 230 a second number of system modules 32 and/or parts of system modules of the plurality of system modules to a second zone 21 of the at least two zones 20-23. Further, the step of “enforcing 200” can comprise allocating 240 a second number of system resources 62, 63 from the plurality of system resources 60-63 to the second zone 22. In the present techniques, system modules or parts thereof that do not belong to the first and second zones, along with the respective system resources, can be allocated to the corresponding other zones that differ from the first and second zones, in the same manner as for the first and second zones. In the methods of the second aspect, allocating system resources to a zone can further comprise allocating corresponding access rights to system resources to such zone.

A third general aspect of the present disclosure relates to a computer program containing instructions that, when executed by a computer system, cause the computer system to perform a computer-implemented method according to the present disclosure.

The present disclosure further relates to a computer-readable medium (e.g., a DVD or a solid-state storage device) containing a computer program of the third general aspect.

The present disclosure further relates to a signal (e.g., an electromagnetic signal according to a wireless or wired communication protocol) that encodes a computer program of the third general aspect.

1-15. (canceled)

16. A computer system for providing a plurality of functions for a device, the computer system comprising:
a plurality of system modules;
a plurality of system resources; and
a security module;
wherein the plurality of system modules are configured to provide functions for the device,
wherein a first zone from a plurality of zones is assigned a first number of system modules and/or parts of system modules of the plurality of system modules,
wherein a second zone from the plurality of zones is assigned a second number of system modules and/or parts of system modules of the plurality of system modules,
wherein each zone of the plurality of zones is a logically and/or physically delimitable unit in the computer system,
wherein the first zone is assigned a first number of system resources from the plurality of system resources,
wherein the second zone is assigned a second number of system resources from the plurality of system resources,
wherein the security module is configured to recognize violations of rules relating to the assignment of the first number of system resources of the plurality of system resources for the first zone and violations of rules relating to the assignment of the second number of system resources of the plurality of system resources for the second zone.

17. The computer system according to claim 16, wherein the device is a vehicle.

18. The computer system according to claim 16, wherein the first zone is more trustworthy than the second, less trustworthy zone, wherein a risk of manipulation of a more trustworthy zone is lower than that of a less trustworthy zone.

19. The computer system according to claim 18, wherein the functions provided by the system modules are of varying criticality for operational reliability of the device, wherein a first more critical function of the plurality of functions is provided by a system module of the first zone and a second less critical function of the plurality of functions is provided by a system module of the second zone.

20. The computer system according to claim 16, wherein zones from the plurality of zones are allocated corresponding access rights to system resources, wherein the second zone is allocated fewer access rights to the second number of system resources than the first zone to the first number of system resources.

21. The computer system according to claim 20, wherein the access rights include at least one of: authorized read access, or authorized write access, or authorized execute access, of a zone of the plurality of zones to a corresponding system resource.

22. The computer system according to claim 20, wherein access for the zone to a system resource is classified as authorized when a predetermined criterion is met, and access for the same zone to the system resource is classified as unauthorized when the predetermined criterion is not met, wherein the predetermined criterion includes one or more of the following criteria:
a predetermined criterion relates to contextual information of the device and/or a plurality of devices;
an expected number of messages sent from a zone in a predetermined time period is less than or equal to a predetermined value;
zone data are sent in a specified sequence and/or whether the data sent contain a range.

23. The computer system according to claim 20, wherein a violation of rules relating to an assigned system resource for a zone corresponds to an unauthorized access by the zone to a system resource for which no access right is assigned to the the zone.

24. The computer system according to claim 16, wherein the security module is assigned to the first zone of the plurality of zones, or to another zone of the plurality of zones that is more trustworthy than the first zone, or to a most trustworthy zone of the plurality of zones.

25. The computer system according to one of the present claim 16, wherein the security module is configured to:
collect information about access to system resources from one or more respective zones of the plurality of zones, wherein the information is provided to the security module by the respective zones;
compare the information about accesses of the one or more respective zones to system resources with information in relation to rules relating to the assignment of system resources for those zones; and
based on a result of the comparison, identify whether there have been any violations of the rules relating to the assignment of system resources for the one or more respecitve zones.

26. The computer system according to claim 16, wherein the security module or another module with which the security module is in communication is configured to trigger a response in a manipulated zone to mitigate effects of manipulation by an external intervention on the computer system, wherein the manipulated zone corresponds to a zone for which violations of rules relating to the assignment of system resources assigned to the zone have been recognized, wherein the response includes initiating a countermeasure against the recognized violations within the manipulated zone.

27. The computer system according to claim 16, wherein the security module or the other module with which the security module is in communication is configured to trigger a response in a non-manipulated zone to mitigate effects of manipulation by an external intervention on the computer system, wherein the response includes initiating a countermeasure in the non-manipulated zone as a result of recognized violations in the manipulated zone.

28. The computer system according to claim 16, wherein:
one or more system modules of the plurality of system modules are configured to query the security module for information about recognized violations in one or more manipulated zones or for other relevant information;
the security module is configured to provide the information to the one or more system modules; and
each of the one or more system modules of the plurality of system modules are further configured to:
identify, from the information on recognized violations, whether violations of rules relating to the assignment of system resources have occurred for one or more zones of the plurality of zones; and
trigger a response in a corresponding zone to which the system module is assigned when violations of rules relating to the assignment of system resources have been identified for at least one zone of the plurality of zones.

29. A computer-implemented method for providing a plurality of functions for a device for a vehicle, by a computer system, the method comprising the following steps:
enforcing a zone separation in the computer system;
providing the plurality of functions for the device; and
recognizing violations of rules relating to an assignment of system resources that are assigned to at least two zones from a plurality of zones.

30. The computer-implemented method according to claim 29, wherein the enforcing of the zone separation in the computer system further includes:
allocating a first number of system modules and/or parts of system modules of a plurality of system modules to a first zone of the at least two zones;
allocating a first number of system resources from a plurality of system resources to the first zone;
allocating a second number of system modules and/or parts of system modules of the plurality of system modules to a second zone of the at least two zones; and
allocating a second number of system resources from the plurality of system resources to the second zone.

31. A non-transitory computer-readable medium on which is stored a computer program containing instructions for providing a plurality of functions for a device for a vehicle, by a computer system, the instructions, when executd by a computer system, causing the computer system to perform the following steps:
enforcing a zone separation in the computer system;
providing the plurality of functions for the device; and
recognizing violations of rules relating to an assignment of system resources that are assigned to at least two zones from a plurality of zones.
